(19) United States
(12) Patent Application Publication
(10) Pub. No.: US 2026/0323575 A1
(43) Pub. Date: Oct. 15, 2026

(54) ENHANCED LOCALIZATION IN WIRELESS PERSONAL AREA NETWORKS

(71) Applicant: Silicon Laboratories Inc., Austin, TX (US)

(72) Inventor: Wael Guibene, McKinney, TX (US)

(21) Appl. No.: 19/175,602

(22) Filed: Apr. 10, 2025

(51) Int. Cl. H04W 64/00; G01S 13/42; H04W 74/0838

(52) U.S. Cl. CPC H04W 64/00; G01S 13/42; H04W 74/0838

(57) ABSTRACT

Techniques for estimating a position of a mobile communications device with sub-meter localization accuracy within a wireless communications network include high-resolution Time-of-Flight and Angle-of-Arrival measurement techniques in combination with synchronized communication schedules using channel access techniques, Kalman filtering-based compensation, and machine learning-based compensation. In an embodiment, a physical layer implements Chirp Spread Spectrum modulation or other pulse compression modulation technique, and enhanced timestamp resolution to achieve finer temporal accuracy within the bandwidth limited by a standard wireless communications protocol. In an embodiment, the physical layer includes multiple antenna arrays and beamforming techniques to capture directional signal information used to determine Angle-of-Arrival. Devices of the wireless communications network are synchronized. In an embodiment, synchronized Time Division Multiple Access scheduling prioritizes localization data frames over normal data frames by using Guaranteed Time Slots for localization data frames.

### BACKGROUND

### Field of the Invention

This application relates to wireless communications systems in general, and more particularly to techniques for determining positions of devices in wireless communications networks.

### Description of the Related Art

In general, localization refers to the process of determining a device or user position in a setting or environment (e.g., an indoor setting or environment). In an exemplary Internet of Things (IoT) system, heterogeneous devices may be configured in a Low-Rate Wireless Personal Area Network (LR-WPAN). Conventional localization techniques for devices compliant with IEEE Standard for Low-Rate Wireless Networks, IEEE Std 802.15.4 (hereinafter “IEEE Standard 802.15.4) rely on Received Signal Strength Indicator (RSSI) and Time-of-Flight (ToF) measurements, which are adversely affected by multipath fading, signal attenuation, and synchronization inaccuracies. Accordingly, improved techniques are desired to achieve sub-meter localization accuracy without substantially increasing power consumption and cost of the LR-WPAN.

### SUMMARY OF EMBODIMENTS OF THE INVENTION

In at least one embodiment, a method for estimating a position of a mobile communications device of a wireless communications network includes communicating normal data frames in timeslots of a contention access period of a wireless communications channel, communicating localization data in guaranteed timeslots of a contention-free access period of the wireless communications channel, and generating a position estimate for the mobile communications device based on the localization data. In an embodiment, the localization data includes Time-of-Flight information and Angle-of-Arrival information. In an embodiment, estimating the position includes generating an initial position estimate based on the Time-of-Flight information using a least squares method. In an embodiment, estimating the position includes applying, to the initial position estimate, a directional correction based on the Angle-of-Arrival information, thereby generating a corrected initial position estimate. In an embodiment, estimating the position includes recursively estimating a position correction based on a series of values of the corrected initial position estimate. In an embodiment, estimating the position includes applying the position correction to the corrected initial position estimate to generate the position estimate. In an embodiment, the method further includes training a machine learning model using the localization data to generate predicted position corrections and updating the position estimate using the predicted position corrections. In an embodiment, the method further includes synchronizing a first wireless communications device of the wireless communications network to a second wireless communications device of the wireless communications network before generating the Time-of-Flight information.

In at least one embodiment, a wireless communications network includes a Time Division Multiple Access (TDMA) scheduler configured to schedule normal data frames in timeslots of a contention access period of a wireless communications channel and to schedule communications of localization data in guaranteed timeslots of a contention-free access period of the wireless communications channel. The wireless communications network includes a central processor configured to estimate a position of a mobile communications device based on the localization data, to thereby generate a position estimate. In an embodiment, the localization data includes Time-of-Flight information and Angle-of-Arrival information. In an embodiment, the network further includes a plurality of antennas configured to communicate signals during the guaranteed timeslots, the signals being used to measure phase differences included in the Angle-of-Arrival information. In an embodiment, the central processor includes a buffer configured to store the Time-of-Flight information and the Angle-of-Arrival information associated with the mobile communications device. In an embodiment, the central processor includes an estimator configured to generate an initial position estimate based on Time-of-Flight information using a least squares method. In an embodiment, the central processor includes a correction processor configured to generate a corrected initial position estimate based on the Angle-of-Arrival information and the initial position estimate. In an embodiment, the central processor includes a Kalman filter configured to recursively estimate a position correction based on a series of values of the corrected initial position estimate. In an embodiment, the central processor is configured to apply the position correction to the corrected initial position estimate to generate the position estimate. In an embodiment, the central processor is further configured to update the position estimate using a predicted position correction. In an embodiment, the network further includes a Chirp Spread Spectrum modulator configured to modulate the Time-of-Flight information and includes high-precision timestampers having resolution finer than a symbol duration to generate timestamps included in the Time-of-Flight information. The timestamps are associated with communications of signals modulated by the Chirp Spread Spectrum modulator.

In at least one embodiment, a method for estimating a position of a mobile communications device in a wireless communications network includes generating an initial position estimate based on Time-of-Flight information and using a least squares method. The method includes applying, to the initial position estimate, a directional correction based on Angle-of-Arrival information, thereby generating a corrected initial position estimate. The method includes recursively estimating a position correction based on a series of values of the corrected initial position estimate. The method includes applying the position correction to the corrected initial position estimate to generate a position estimate. In an embodiment, the method includes training a machine learning model using the localization data to generate predicted position corrections. In an embodiment, the method includes updating the position estimate using the predicted position corrections.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary wireless communications network.

FIG. 2 illustrates a functional block diagram of an exemplary central processing device and a mobile communications device of the wireless communications network of FIG. 1.

FIG. 3 illustrates abstraction layers for hardware and software of an exemplary device of the wireless communications network of FIG. 1.

FIG. 4 illustrates synchronized Time Division Multiple Access scheduling for localization data prioritization in the wireless communications network of FIG. 1.

FIG. 5 illustrates exemplary information and control flows for an exemplary device in the wireless communications network of FIG. 1.

FIG. 6 illustrates exemplary information and control flows for location estimation in the wireless communications network of FIG. 1.

FIG. 7 illustrates an exemplary frame format for the wireless communications network of FIG. 1.

The use of the same reference symbols in different drawings indicates similar or identical items.

### DETAILED DESCRIPTION

Techniques for estimating a position of a mobile communications device with sub-meter localization accuracy within an LR-WPAN include high-resolution Time-of-Flight (ToF) and Angle-of-Arrival (AoA) measurements in combination with synchronized communication schedules using channel access techniques, Kalman filtering, and machine learning-based compensation implemented in Physical (PHY) layers and Medium Access Controller (MAC) layers of a LR-WPAN. In an embodiment, the PHY layers implement Chirp Spread Spectrum (CSS) modulation or other pulse compression modulation technique and implement enhanced timestamp resolution to achieve finer temporal accuracy within the available bandwidth, which is limited by a standard wireless communications protocol. In an embodiment, the PHY layers include multiple antennas and devices use beamforming techniques to capture directional signal information for determining AoA. In some embodiment, devices of the LR-WPAN are synchronized using techniques consistent with the standard wireless communications protocol (e.g., IEEE Standard 802.15.4).

In an embodiment, the MAC layer implements synchronized Time Division Multiple Access (TDMA) scheduling that uses a superframe structure to coordinate signal transmissions, thereby reducing the likelihood of packet collisions. In an embodiment, the MAC layers implement adaptive frequency hopping, which includes dynamic channel switching within channels allocated by the standard to reduce interference and increase signal reliability. In at least one embodiment, MAC layers implement Carrier-Sense Multiple Access Collision Avoidance (CSMA/CA) techniques and Quality of Service (QoS) Enhancements. For example, a MAC layer prioritizes localization frames over regular data traffic by communicating localization data in Guaranteed Time Slots (GTS) of a superframe.

In at least one embodiment, a localization technique uses Kalman filtering to refine position estimates by recursively predicting and applying a position correction based on a series of measurement data. In at least one embodiment, the localization technique uses a machine learning model to compensate for the effects of environmental factors on signal propagation. For example, a machine learning model (e.g., Random Forest machine learning model or other known machine learning model) is used to generate corrections for environmental factors that distort ToF and AoA data using data (e.g., ToF, AoA, and RSSI and temperature, humidity, interference, or other environmental parameters) collected while a device is at known reference positions. Features (e.g., raw measurements of distance, angle, RSSI, and environment data, device orientation and channel usage) and labels (e.g., known positions or distance offsets) are used to train the Random Forest machine learning model to classify and predict how different environmental factors affect measurement accuracy. At run time, the model receives the raw measurements and environment data as inputs, and it predicts corrections to be applied to localization estimates. This technique accounts for multipath interference and attenuation, or other environment-specific factors and refines position estimates without manually modelling each source of error.

In at least one embodiment, the frame structure of the communications protocol is adapted to encapsulate localization-specific data, including precise timestamps and AoA information. In at least one embodiment, a dedicated synchronization message introduces a high-precision timing synchronization frame that is used to unify temporal frameworks across devices of the network. Accordingly, an IEEE Standard 802.15.4-based network is able to achieve submeter localization accuracy (e.g., accuracy to within 0.5 meters) while maintaining scalability, low power consumption, and compatibility with existing network infrastructures.

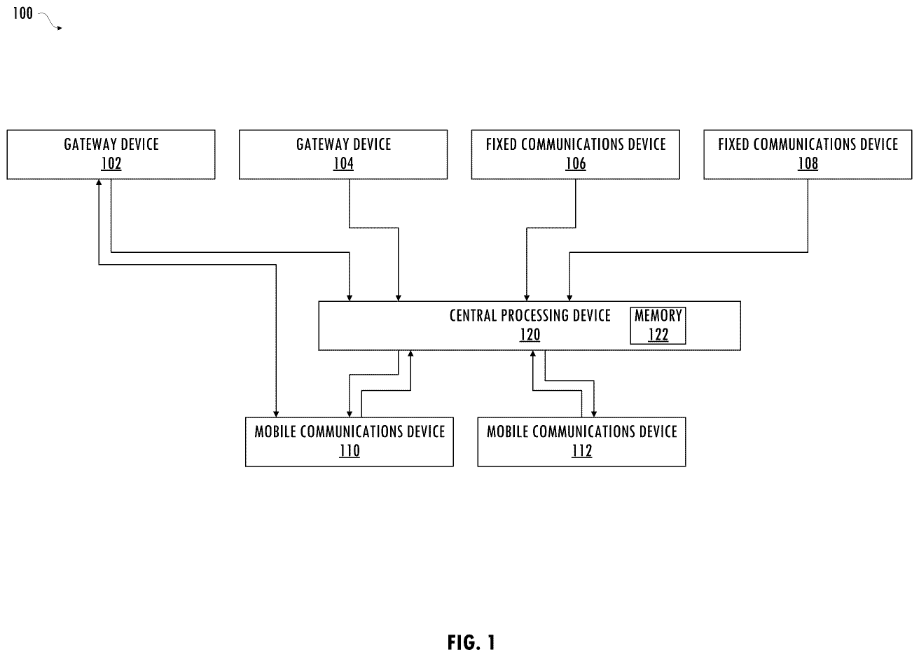

Referring to FIG. 1, in an embodiment, a wireless communications network includes heterogeneous devices configured in a mesh network, e.g., gateway device 102, gateway device 104, fixed communications device 106, fixed communications device 108, mobile communications device 110, mobile communications device 112, and central processing device 120. In an embodiment, central processing device 120 is a dedicated, standalone device within network 100 and coordinates data from gateway devices, fixed devices, or mobile devices. In at least one embodiment, the functionality of central processing device 120 is integrated into a gateway device or Thread border router. For example, in an embodiment of network 100, gateway 102 and gateway 104 are Thread border routers that serve as network gateways and the Thread border router hardware and software also provides the functionality of central processing device 120. In at least one embodiment, central processing device 120 is an industrial IoT hub or edge server running on a multi-core system-on-chip (SoC) that includes high-precision timers, extended memory, and enhanced computing resources configured for localization, synchronization, and data aggregation tasks described herein.

In an embodiment, network 100 is compliant with an IPV6-based networking protocol designed for low-power IoT devices in an IEEE 802.15.4-2006 wireless mesh network (e.g., network 100 is compliant with Thread®). In at least some embodiments, gateway device 102 and gateway device 104 (e.g., Thread border routers that serve as gateways between the Thread network and the Internet) are connection points between IoT devices or sensors (e.g., fixed communications device 106, fixed communications device 108, mobile communications device 110, and mobile communications device 112) and external devices. In at least some embodiments, gateway device 102 and gateway device 104 are central hub devices that include PHY and MAC layers with features for synchronization and improved localization. For example, gateway device 102 and gateway device 104 include multiple antennas and high precision timers (i.e., timers that are stable over temperature and voltage variations and have resolution at least an order of magnitude finer than a symbol duration, e.g., having resolution finer than 1 μs where the symbol duration is 16 μs). In at least one embodiment, the timers have resolution in the nanosecond range.

In at least some embodiments, fixed communications device 106 and fixed communications device 108 are stationary devices (e.g., smart switches or door locks implementing a Thread protocol) that provide additional data for triangulation of position. In addition, embodiments of those stationary devices include multiple antennas and high-precision timers. In at least some embodiments, mobile communications device 110 and mobile communications device 112 are embodiments of devices (e.g., smartphones or wearables) having variable positions that are to be determined with high accuracy (e.g., sub-meter accuracy). In at least some embodiments, mobile communications device 110 and mobile communications device 112 include radios and firmware compliant with IEEE standard 802.15.4 and are enhanced with features for localization. In at least some embodiments, central processing device 120 aggregates data received from gateway device 102, gateway device 104, fixed communications device 106, and fixed communications device 108, executes localization algorithms, and estimates positions of mobile communications device 110 and mobile communications device 112 based on the aggregated data. In at least some embodiments, central processing device 120 includes hardware, software, which includes firmware (e.g., instructions stored in memory 122), or combinations thereof, for data collection, signal processing, algorithm execution, and user interfacing.

In at least one embodiment of network 100, the PHY layer, which is implemented on each device, is compliant with IEEE standard 802.15.4 and includes additional features that can be used to generate a precise estimate of the distance between central processing device 120 and another device (e.g., mobile communications device 110 or mobile communications device 112). The PHY layer implements a high-resolution ToF measurement of a signal travel time between a transmitting device and a receiving device to generate the precise estimate. In at least one embodiment, the PHY layer on each device of network 100 has enhanced timestamp resolution by including clocks with resolutions at least two orders of magnitude finer than those required by IEEE standard 802.15.4. For example, in the 2.4 GHz frequency band, symbol duration T_{sym} is 16 μs and the PHY layer uses timers or timestampers with at least two orders of magnitude higher resolution (e.g., timestampers having 1 ns resolution) to make ToF measurements. In at least one embodiment, the PHY layer uses Offset-Quadrature Phase-Shift Keying (O-QPSK) modulation for the 2.4 GHz band or Chirp Spread Spectrum (CSS) modulation. In at least one embodiment, the PHY layer uses Reed-Solomon error correction codes and convolutional codes.

In at least one embodiment, the PHY layer uses CSS modulation and operates within the bandwidth limitations of IEEE standard 802.15.4. CSS uses wideband linear frequency modulated pulses of a chirp signal (i.e., pulses of a sinusoidal signal whose frequency increases or decreases over time) to encode information. In general, CSS is resistant to channel noise and multi-path fading even when operating at very low power. In at least one embodiment, CSS modulation is a pulse compression technique that includes transmitting a long-duration, wideband chirp signal and compressing it into a short-duration, high-amplitude pulse at the receiver by using matched filtering. The matched filtering correlates the received signal with a replica of the transmitted chirp signal.

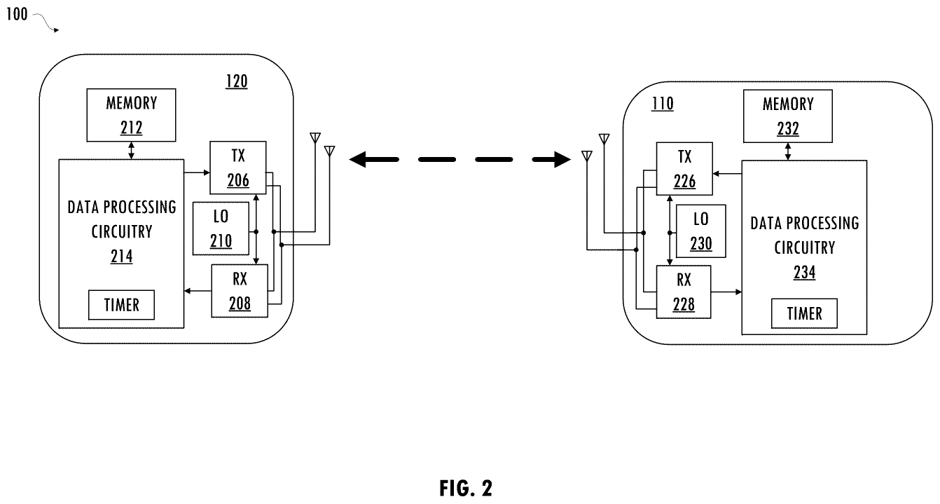

In at least one embodiment, network 100 is a typical Internet of Things (IoT) wireless communications device-based product that is operable according to a wireless protocol such as IEEE Standard 802.15.4 based protocols (Zigbee® and Thread). Referring to FIG. 2, in at least one embodiment, network 100, central processing device 120 includes transmitter 206, receiver 208, data processing circuitry 214, memory 212, and local oscillator 210. Mobile communications device 110 includes transmitter 226, receiver 228, data processing circuitry 234, memory 232, and local oscillator 230. Local oscillator 210 and local oscillator 230 provide signals used in functions of central processing device 120 and mobile communications device 110, respectively. In addition, central processing device 120 and mobile communications device 110 each use a corresponding free-running timer to track time and may be included in corresponding data processing circuitry or other portion of the corresponding device. In at least one embodiment of mobile communications device 110, transmitter 226, receiver 228, local oscillator 230, data processing circuitry 234, and memory 232 are included in a controller integrated circuit device implementing a link layer of a communications protocol and implementing PHY layer of the communications protocol.

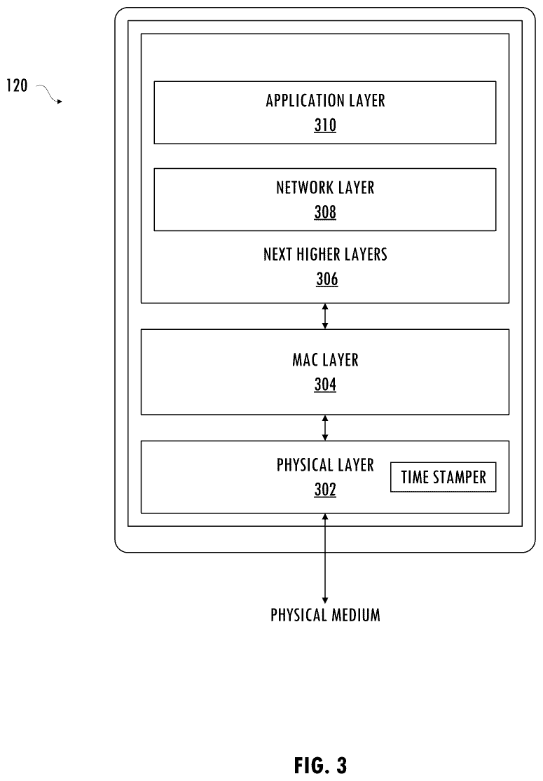

Referring to FIG. 3, in at least one embodiment of a wireless network, each device of the wireless network implements an LR-WPAN device architecture. Each of the separate devices includes a free-running clock and operates using separate timers or time bases. For example, in an embodiment, mobile communications device 110 includes at least one PHY layer 302, which includes the radio frequency (RF) transceiver and associated control mechanisms (e.g., in application specific circuits and general purpose computing circuits and firmware executing thereon) and MAC layer 304 provides access to the physical channel for all types of transfer. Next higher layers 306 includes network layer 308, which provides network configuration, manipulation, and message routing, and includes application layer 310, which provides the intended function of the device. In an embodiment, each PHY layer 302 provides activation and deactivation, energy detection, link quality indications, channel selection, Clear Channel Assessment (CCA) techniques, ranging, and transmitting and receiving packets over the physical medium. In an embodiment, MAC layer 304 provides MAC data service and MAC management service. The MAC data service enables transmission and reception of MAC Protocol Data Units (PDUs) across the PHY data service. In an embodiment, MAC layer 304 provides beacon management, channel access, GTS management, frame validation, acknowledged frame delivery, association, and disassociation. In addition, MAC layer 304 provides features for implementing application-specific security mechanisms.

Referring to FIGS. 1 and 3, in an embodiment, PHY layer 302 implements precise timestamping techniques to synchronize clocks of all devices coupled to the central processing device, e.g., with sub-microsecond accuracy. In an embodiment, central processing device 120 computes ToF as follows:

ToF=tᵣ−tₗ−δ,

where tᵣ is the time at transmission of a frame, tᵣ is the time at reception of the frame, and δ is a system-induced delay. Distance d is calculated as follows:

$$d = \frac{T o F \times c}{2} ,$$

where c is the speed of light (i.e., 3×10⁸ m/s) and the divide-by-two accounts for the round-trip time, where applicable.

In at least one embodiment, gateway device 102, gateway device 104, fixed communications device 106, fixed communications device 108, mobile communications device 110, mobile communications device 112, and central processing device 120 are synchronized. Time synchronization is achieved by central processing device 120 sending a sync message at time tₗ to another device of network 100. In at least one embodiment, network 100 implements synchronization within sub-microsecond accuracy consistent with IEEE Std 1588-2019 “IEEE Standard for a Precision Clock Synchronization Protocol for Networked Measurement and Control Systems.” In at least one embodiment, central processing device 120 determines local time tₗ for device i:

tᵢ=tⱼ+Δᵢⱼ+∈,
where tⱼ is the local time of device j;
Δᵢⱼ is the offset between devices; and
ϵ is synchronization error. In at least one embodiment, each of the devices in network 100 performs a local clock adjustment, to generate corrected frequency f′ᵢ, which is based on frequency offset correction Δfᵢ, and generates corrected phase φ′ᵢ, which is based on phase correction Δφᵢ:
f′ᵢ=fᵢ+Δfᵢ; and
φ′ᵢ=φᵢ+Δφᵢ.
   In an embodiment, a device determines phase correction Δφᵢ using a timestamp in a synchronization frame received from a central processing device and a local timestamp corresponding to the arrival of the synchronization frame. In an embodiment, the device determines frequency offset correction Δfᵢ by determining how the phase offset varies across multiple synchronization intervals. The rate of this change over known reference intervals indicates a difference in frequency from the clock of the central processing device.

In an embodiment of network 100, central processing device 120 sends a message including precise timestamp tᵢ to another device. The other device sends a delay request message at time t₂ to central processing device 120. Central processing device 120 responds with a delay response message, which includes timestamps t₃ and t₄. To synchronize the other device with central processing device 120, central processing device 120 determines a round-trip delay d using the timestamps from the messages (e.g., d=((t₄−tₗ)−(t₃−t₂)/2, where (t₄−t₁) is the total time from the time that central processing device 120 sends a synchronization message to the time that central processing device 120 receives a delay request message, and (t₃−t₂) is the time taken by the other device to send the delay request message and receive the delay response message. Central processing device 120 calculates offset o between the clock of central processing device 120 and the clock of the other device (e.g., o=((t₂−t₁)+(t₃−t₄))/2, which is the difference in time between the clock of central processing device 120 and the clock of the other device. In an embodiment, the other device adjusts its clock by adding the calculated offset, o, to its current time to synchronize with the clock of central processing device 120.

In an embodiment, central processing device 120 determines the direction from which a signal arrives for use in triangulating the position of the mobile communications device. Central processing device 120 or other communications device measure phase differences by using N antennas, where Nis an integer of at least two. The antennas are spaced within physical constraints of the corresponding device and consistent with the IEEE standard 802.15.4. In an embodiment, the antennas are spaced apart by a half wavelength (or other fraction of a wavelength appropriate for the 2.4 GHz band). In at least one embodiment, antennas are spaced within a form factor of a device to ensure the phase difference measurements are large enough to sufficiently distinguish angles for AoA measurements. In at least one embodiment, antennas are spaced to reduce or eliminate spatial aliasing or to ensure that each antenna receives a signal at a detectably different phase. In at least one embodiment, antennas are positioned and oriented in arrays to improve localization of a mobile device consistent with the IEEE standard 802.15.4. In at least one embodiment, antenna array designs trade off localization performance with device size and signal processing complexity. Central processing device 120 determines a phase difference between signals received on different antennas where a received signal is represented as

rₙ(t)=Ae^{j(2πft+φ}^{ₙ}⁾,

where φₙ is the phase shift at antenna n.
Phase difference Δφ_{n,m} is
Δφ_{n,m}=φₙ−φₘ, where n and m are indices for different antennas;

$$Δ {ϕ}_{n , m} = 2 π \frac{d}{λ} sin ( θ ) ,$$

where λ is the wavelength of the signal, and the Angle-of-Arrival is

$$θ = arcsin ( \frac{λΔ {ϕ}_{n , m}}{2 π d} ) .$$

In at least one embodiment of network 100, the MAC layer coordinates transmissions and receptions of localization data to reduce collisions and improve reliability of localization signal exchanges, thereby improving the accuracy of localization. The MAC layer implements TDMA using a superframe structure having a Contention Access Period (CAP) and a Contention Free Period (CFP). The CFP includes at least one Guaranteed Time Slot (GTS) that is dedicated to the corresponding device. In an embodiment, multiple GTS are used and occupy contiguous time slots of the superframe. Localization data is communicated in a corresponding GTS of the CFP.

In at least one embodiment, beacons are used to communicate control information for synchronizing devices and defining superframe boundaries. In at least one embodiment, conventional time slot durations are used (e.g., 960 symbols). In at least one embodiment, timing synchronization is achieved using beacon frames that communicate information including high-resolution timestamps and a two-way time transfer value is generated:

$${t}_{offset} = \frac{( {t}_{r 1} - {t}_{t 1} ) - ( {t}_{r 2} - {t}_{t 2} )}{2} .$$

In at least one embodiment, the MAC layer implements collision avoidance strategies to prevent simultaneous transmissions that can lead to data collisions. For example, the MAC layer implements Carrier Sense Multiple Access (CSMA) with Collision-Avoidance (CA) implemented with random backoff periods within the CAP. The MAC layer implements CCA techniques that configure devices to listen to check if channel is idle before transmitting localization data. In at least one embodiment, the MAC layer improves quality of service for localization data by prioritizing communication of frames including localization data over frames including regular data traffic. The MAC layer assigns localization data to reserved time slots in a GTS. The MAC layer reserves fraction α of the total time slots for GTS (i.e., number of reserved time slots=α×number of total time slots). In at least one embodiment, the MAC layer sets frame priority bits for localization data. For example, the MAC layer uses reserved or vendor-specific bits in the Frame Control Field (FRF) of the MAC header or uses Information Elements (IE) of the MAC header to indicate that a corresponding frame including should receive increased priority for including localization data.

In at least one embodiment, frequency hopping is used to reduce interference and enhance signal reliability by dynamic channel switching. For example, the system first determines which channels of the IEEE Standard 802.15.4 for the 2.4 GHz band (e.g., channels 11 to 26 having frequencies in the range of 2405 MHz-2430 MHz) are available for frequency hopping. The MAC layer scheduler reserves time slots for normal data traffic in the CAP and for high-priority localization frames in the GTS. Before each slot or superframe boundary, the scheduler selects a channel to be used next. In an embodiment, the scheduler uses a pseudo-random channel selection algorithm (e.g., using a linear feedback shift register (LFSR) or a hashed channel index) to select the next channel in a predetermined frequency hopping sequence. All devices in the network know the predetermined frequency hopping sequence e.g., by having it compiled into firmware or by learning it from messages (e.g., beacon frames that carry a seed value for the LFSR). To ensure that all devices in the network are synchronized with the frequency hopping sequence, a coordinator device or other authoritative device broadcasts beacon frames or synchronization frames containing the index of the next channel (or seed for a pseudo-random sequence), timing offsets so devices know when one superframe ends and the next superframe begins. Each device in the network uses information in the beacon messages to synchronize its local clock so that in response to a superframe boundary, the device hops to the same channel as the other devices in the network.

During normal operation, devices may monitor link quality metrics on the current channel (e.g., error rates, packet retries, RSSIs). If a channel has consistently poor link quality (e.g., due to interference from Wi-Fi or other 2.4 GHz sources, then the scheduler temporarily blacklists or deprioritizes that channel in the frequency hopping sequence. For example, the schedule adjusts a weight for each channel to favor channels that have recently shown higher signal quality. During the CAP, devices continue to use CSMA/CA to reduce or eliminate collisions on the current channel. During the CFP, devices use GTS to send latency-critical localization data without interference on the current channel, thereby reducing or eliminating collisions. By frequency hopping to a different channel every superframe (or every timeslot, depending on configuration), devices are less likely to continuously communicate on a noisy channel. If a device encounters heavy noise on a channel (e.g., from nearby 2.4 GHz Wi-Fi) then the noise interferes only temporarily before the system hops to a channel with less interference. Over time, the frequency hopping sequence spreads across multiple channels reducing the likelihood of overuse of one or two individual channels.

In at least one embodiment, the frequency hopping mechanism described above is applied to localization frames. If high-priority, time sensitive localization data is scheduled in GTS, then the system hops the entire network to a designated channel prior to that slot, broadcasts the localization frame, and hops again for subsequent slots. By combining frequency hopping with GTS allocations, the network prioritizes and protects critical localization messages across multiple channels. Thus, the devices in the network share a synchronized timetable (e.g., via beacons or coordinator messages), use the same pseudo-random frequency hopping pattern, and continuously gather channel-quality feedback to reduce or eliminate interference.

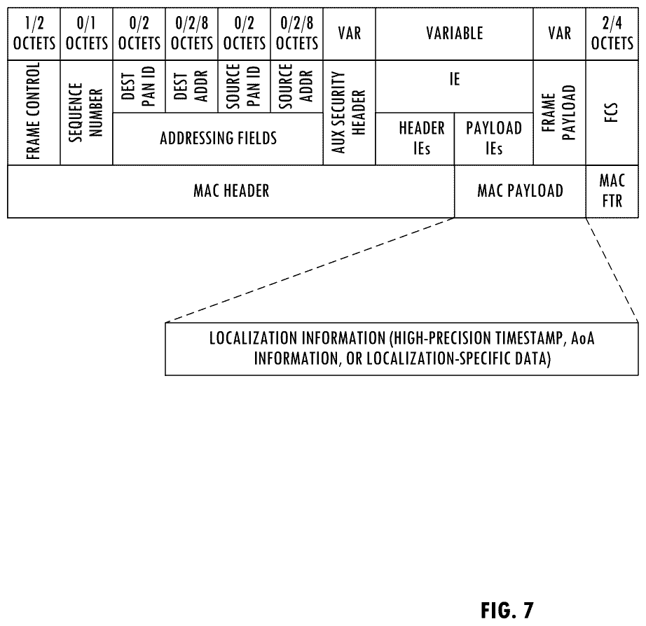

Referring to FIG. 7, in at least one embodiment, location-specific data is encapsulated in reserved frame fields, e.g., reserved bits in the MAC header or MAC payload of a frame. In at least one embodiment, MAC payload data includes localization data (e.g., high-precision timestamps, AoA information, quality metrics, or other localization-specific data).

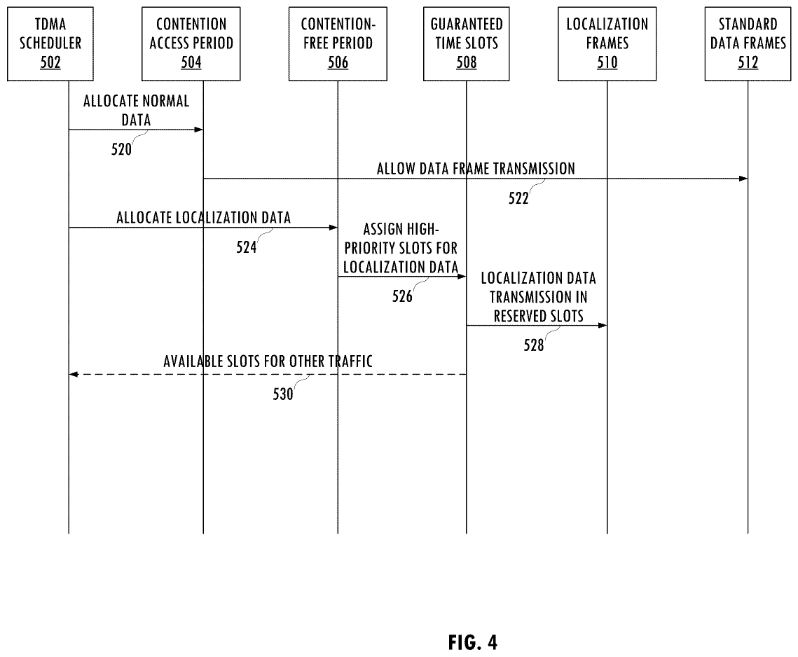

Referring to FIGS. 3 and 4, in at least one embodiment, MAC layer 304 includes TDMA scheduler 502, which allocates time slots for normal data communications (520). During contention access period 504, MAC layer 304 allows transmissions of standard data frames 512 (522). In addition, TDMA scheduler 502 allocates localization data to contention-free period 506 (524). During contention-free period 506, MAC layer 304 assigns localization data to GTS 508 or other high priority time slots (526). MAC layer 304 communicates localization data frames 510 in reserved timeslots (528). After assigning any localization data to the GTS, MAC layer 304 uses any remaining GTS of the CFP for other traffic (530). Channels are allocated based on network needs to reduce or eliminate conflicts. In at least one embodiment, specific channels are allocated for localization data. For example, channels 11 to 26, which are the furthest from Wi-Fi channels, are used to reduce or eliminate effects of Wi-Fi interference. Quality of service enhancements include prioritizing localization frames by using GTS during CFP for localization data or setting frame priority bits in a frame control field of a MAC header.

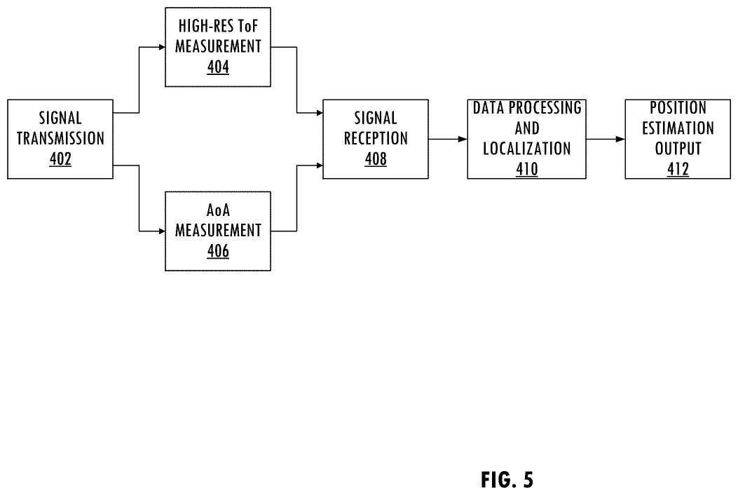

Referring to FIGS. 3 and 5, in at least one embodiment, central processing device 120 includes PHY layer 302, which communicates signals using enhanced timestamping techniques described above (402) to perform a high-resolution ToF measurement (404). In addition, PHY layer 302 uses antenna arrays and beamforming to determine an AoA measurement (406). PHY layer 302 uses CSS and a multi-antenna array to communicate signals received by central processing device 120 (408). Central processing device 120 processes the localization data using localization algorithms (410) and generates a position estimate output (412).

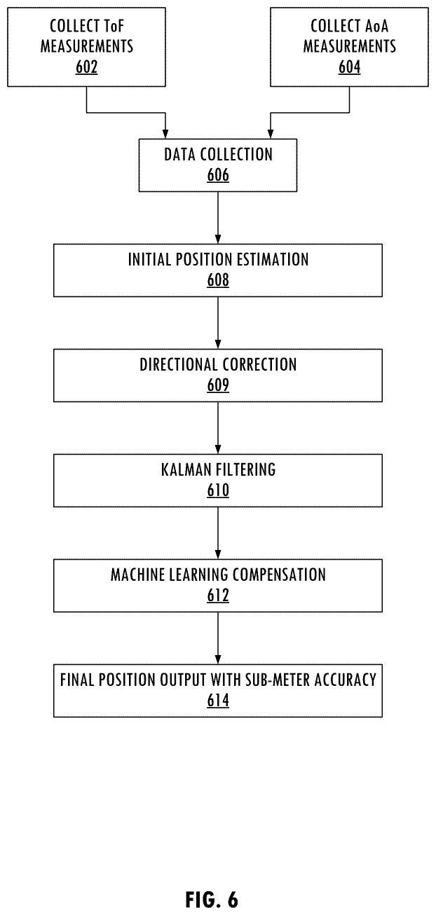

Referring to FIGS. 3 and 6, in at least one embodiment, application layer 310 of central processing device 120 processes the AoA and ToF information to estimate device position. In an embodiment, application layer 310 combines ToF distance estimates with AoA directional information to estimate device position. For example, PHY layer 302 and MAC layer 304 collect ToF distance measurements di (602) and collect AoA measurements θᵢ from multiple reference points (604) and application layer 310 stores those measurements in data collection (606). Application layer 310 uses a least squares method to estimate initial position pi=[xᵢ, yᵢ]^{T} of the device based on those data (608):

$$p = arg {min}_{P} {\sum }_{i = 1}^{N} {( \sqrt{{( x - {x}_{i} )}^{2} + {( y - {y}_{i} )}^{2}} - {d}_{i} )}^{2} ,$$

where p=[x, y]^{T} is the estimated position. Then, application layer 310 applies a directional correction generated based on the AoA directional information (609):

$${p}^{′} = p + {\sum }_{i = 1}^{N} {w}_{i} {v}_{i} ,$$

$$where {v}_{i} = [ \begin{matrix}cos ( {θ}_{i} ) \\ sin ( {θ}_{i} )\end{matrix} ] ,$$

and
where wᵢ are weight factors.

In at least one embodiment, Kalman filtering techniques refine the position over time (e.g., recursively estimates a correct estimate and generates a corresponding correction value over time) (610) using state vector xₖ, error covariance matrices P_{(k|k-1)} and P_{(k|k)}, Kalman gain Kₖ, state transition matrix F, measurement noise covariance matrix R, and covariance for noise process Q, where

$${x}_{k} = [ \begin{matrix}{x}_{k} \\ {y}_{k} \\ {v}_{x , k} \\ {v}_{y , k}\end{matrix} ] ; and$$

$${x}_{( k \vert k - 1 )} = {Fx}_{( k - 1 \vert k - 1 )} ;$$

$${P}_{( k \vert k - 1 )} = {FP}_{( k - 1 \vert k - 1 ) F}^{T} + Q ;$$

$${K}_{k} = {{P}_{( k \vert k - 1 ) H}^{T} ( {HP}_{( k \vert k - 1 ) H}^{T} + R )}^{- 1} ;$$

$${x}_{( k \vert k )} = {x}_{( k \vert k - 1 )} + {K}_{k} ( {z}_{k} - {Hx}_{( k \vert k - 1 )} ) ;$$

$${P}_{( k \vert k )} = ( 1 - {K}_{k} H ) {P}_{( k \vert k - 1 )} .$$

For example,

$$F = [ \begin{matrix}1 & 0 & Δ t & 0 \\ 0 & 1 & 0 & Δ t \\ 0 & 0 & 1 & 0 \\ 0 & 0 & 0 & 1\end{matrix} ]$$

where Δt is the time step; and
if measurements are (zₓ, z_{y}) position readings, then

$$R = [ \begin{matrix}{σ}_{x}^{2} & 0 \\ 0 & {σ}_{y}^{2}\end{matrix} ] , where {σ}_{x}^{2} and {σ}_{y}^{2}$$

are measurement noise variances for x and y.
The output of the Kalman filtering is used to compensate the estimated position and generate a compensated estimate that is further corrected using outputs of one or more machine learning model (612). For example, ToF measurements, AoA data, RSSI information, or environmental indicators or other information regarding factors that affect signal propagation are used to generate corrections. Data sets for known positions (e.g., data sets for fixed communications device 106 and fixed communications device 108 of FIG. 1) are used to train regression models. The models provide predicted corrections (Δp), which are used to adjust position estimates:

P_{final}=Pᵢₙᵢₜᵢₐₗ+Δp.

Referring to FIG. 6, after machine learning compensation, the application layer provides final device position output having sub-meter accuracy (614). The sequence of FIG. 6 is exemplary only and other sequences for combining ToA and AoA measurements, Kalman filtering, and machine learning compensation may be used. For example, in other embodiments, machine learning compensation precedes Kalman filtering or updates based on Kalman filtering and machine learning compensation are performed repeatedly until convergence rather than performing each one time, in series. In other embodiments, Kalman filtering or machine learning compensation is omitted. For example, if the environment is stable, sufficient localization accuracy is achieved without Kalman filtering or machine learning compensation.

Thus, techniques for determining the position of a device in a low-rate wireless personal area network are described. The description of the invention set forth herein is illustrative and is not intended to limit the scope of the invention as set forth in the following claims. For example, while the invention has been described in an embodiment implementing a Thread protocol, other embodiments implement other communications protocols. The terms “first,” “second,” “third,” and so forth, as used in the claims, unless otherwise clear by context, are to distinguish between different items in the claims and do not otherwise indicate or imply any order in time, location, or quality. For example, “a first received signal” and “a second received signal” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for estimating a position of a mobile communications device of a wireless communications network, the method comprising:
communicating normal data frames in timeslots of a contention access period of a wireless communications channel;
communicating localization data in guaranteed timeslots of a contention-free access period of the wireless communications channel; and
generating a position estimate for the mobile communications device based on the localization data.

2. The method as recited in claim 1 wherein the localization data includes Time-of-Flight information and Angle-of-Arrival information.

3. The method as recited in claim 2 wherein estimating the position comprises:
generating an initial position estimate based on the Time-of-Flight information using a least squares method;
applying, to the initial position estimate, a directional correction based on the Angle-of-Arrival information, thereby generating a corrected initial position estimate;
recursively estimating a position correction based on a series of values of the corrected initial position estimate; and
applying the position correction to the corrected initial position estimate to generate the position estimate.

4. The method as recited in claim 3 further comprising:
training a machine learning model using the localization data to generate predicted position corrections; and
updating the position estimate using the predicted position corrections.

5. The method as recited in claim 2 wherein the method further comprises:
using Chirp Spread Spectrum modulation of the Time-of-Flight information during the guaranteed timeslots; and
measuring phase differences of signals captured during the guaranteed timeslots using a plurality of antennas to generate at least some of the Angle-of-Arrival information.

6. The method as recited in claim 2 further comprising:
synchronizing a first wireless communications device of the wireless communications network to a second wireless communications device of the wireless communications network before generating the Time-of-Flight information.

7. The method as recited in claim 1 further comprising:
receiving a location query by a central processor device from the mobile communications device,
wherein the communicating localization data comprises sending a high-precision timestamp by the central processor device to the mobile communications device in response to the location query.

8. The method as recited in claim 7 further comprising:
receiving at least some of the localization data by the central processor device from a stationary communications device, an additional mobile communications device, or a gateway device.

9. The method as recited in claim 1 further comprising:
scheduling the normal data frames in the timeslots of the contention access period and the localization data in the guaranteed timeslots of the contention-free access period.

10. The method as recited in claim 1 wherein communicating the localization data comprises:
communicating a packet including a payload having a high-precision timestamp field, an Angle-of-Arrival data field, and a localization-specific data field.

11. A wireless communications network comprising:
a Time Division Multiple Access (TDMA) scheduler configured to schedule normal data frames in timeslots of a contention access period of a wireless communications channel and to schedule communications of localization data in guaranteed timeslots of a contention-free access period of the wireless communications channel; and
a central processing device configured to estimate a position of a mobile communications device based on the localization data, to thereby generate a position estimate.

12. The wireless communications network as recited in claim 11 wherein the localization data includes Time-of-Flight information and Angle-of-Arrival information.

13. The wireless communications network as recited in claim 12 wherein the network further comprises:
a plurality of antennas configured to communicate signals during the guaranteed timeslots, the signals being used to measure phase differences included in the Angle-of-Arrival information.

14. The wireless communications network as recited in claim 12 wherein the central processor comprises:
a buffer configured to store the Time-of-Flight information and the Angle-of-Arrival information associated with the mobile communications device;
an estimator configured to generate an initial position estimate based on Time-of-Flight information using a least squares method;
a correction processor configured to generate a corrected initial position estimate based on the Angle-of-Arrival information and the initial position estimate; and
a Kalman filter configured to recursively estimate a position correction based on a series of values of the corrected initial position estimate,
wherein the central processor is configured to apply the position correction to the corrected initial position estimate to generate the position estimate.

15. The wireless communications network as recited in claim 14 wherein the central processor is further configured to update the position estimate using a predicted position correction.

16. The wireless communications network as recited in claim 12 wherein the network further comprises:
a Chirp Spread Spectrum modulator configured to modulate the Time-of-Flight information; and
high-precision timestampers having resolution finer than a symbol duration to generate timestamps included in the Time-of-Flight information, the timestamps being associated with communications of signals modulated by the Chirp Spread Spectrum modulator.

17. The wireless communications network as recited in claim 11 further comprising:
an additional gateway, an additional mobile communications device, or a stationary communications device configured to provide at least some of the localization data.

18. A method for estimating a position of a mobile communications device in a wireless communications network, the method comprising:
generating an initial position estimate based on Time-of-Flight information and using a least squares method;
applying, to the initial position estimate, a directional correction based on Angle-of-Arrival information, thereby generating a corrected initial position estimate;
recursively estimating a position correction based on a series of values of the corrected initial position estimate; and
applying the position correction to the corrected initial position estimate to generate a position estimate.

19. The method as recited in claim 18 further comprising:
training a machine learning model using the localization data to generate predicted position corrections; and
updating the position estimate using the predicted position corrections.

20. The method as recited in claim 18 further comprising:
communicating normal data frames in timeslots of a contention access period of a wireless communications channel; and
communicating localization data in guaranteed timeslots of a contention-free access period of the wireless communications channel,
wherein the localization data includes the Time-of-Flight information and the Angle-of-Arrival information.
